(19) United States
(12) Patent Application Publication
(10) Pub. No.: US 2025/0334113 A1
(43) Pub. Date: Oct. 30, 2025

(54) MONITORING APPARATUS AND METHOD FOR A SPRINKLER PUMP TEST RUN

(71) Applicant: MECON GmbH, Overath (DE)

(72) Inventors: Joachim Böke, Düsseldorf (DE); Frank Friede, Ratzeburg (DE); Alexander Derksen, Grinau (DE)

(21) Appl. No.: 19/186,841

(22) Filed: Apr. 23, 2025

(30) Foreign Application Priority Data
Apr. 24, 2024 (DE) 102024111475.4

(51) Int. Cl. F04B 51/00; A62C 37/50; F04B 49/02

(52) U.S. Cl. CPC F04B 51/00; A62C 37/50; F04B 49/02

(57) ABSTRACT

A monitoring apparatus for a pump test run of a sprinkler pump. The sprinkler includes at least one pump housing surrounding a wet chamber, a drive shaft arranged sealed against the pump housing by a gland packing, and a drive mechanically coupled to the drive shaft, the gland packing being configured and adapted for the passage of leakage fluid from the pump housing into a dry chamber. The monitoring apparatus includes a measuring unit adapted to detect the leakage fluid passing through the gland packing from the pump housing into the dry chamber during the pump test run, and is configured to generate a stop signal to switch off the sprinkler pump and/or an alarm signal if the flow rate falls below a predefined minimum.

### CROSS-REFERENCE TO RELATED APPLICATIONS

This application claims priority to German Patent Application No. 102024111475.4 filed on Apr. 24, 2024, which is herein incorporated by reference in its entirety.

### TECHNICAL FIELD

The present disclosure relates to a monitoring apparatus for a pump testrun of a sprinkler pump, wherein the sprinkler pump comprises at least one pump housing surrounding a wet chamber, a drive shaft arranged sealed against the pump housing by a gland packing, and a drive mechanically coupled to the drive shaft, the gland packing being configured and adapted for the passage of leakage fluid from the pump housing into a dry chamber.

The present disclosure further relates to a method for monitoring a pump test run of a sprinkler pump, wherein the sprinkler pump comprises at least one pump housing surrounding a wet chamber, a drive shaft arranged sealed against the pump housing by a gland packing, and a drive mechanically coupled to the drive shaft, the gland packing being configured and adapted for the passage of leakage fluid from the pump housing into the dry chamber.

A third aspect of the present disclosure relates to a monitoring apparatus for a pump, wherein the pump comprises at least one pump housing surrounding a wet chamber, a drive shaft arranged sealed against the pump housing by a gland packing, and a drive mechanically coupled to the drive shaft, the gland packing being configured and adapted for the passage of leakage fluid from the pump housing into a dry chamber.

The present disclosure further relates to a water extinguishing system.

### BACKGROUND

Water extinguishing systems, in particular sprinkler systems, are used to fight fires. Pumps, especially sprinkler pumps for delivering extinguishing fluid, are a functional component of such water extinguishing systems. The sprinkler pump is only started in the event of a fire and during a pump test run. In the event of a fire, the sprinkler pump delivers extinguishing fluid to nozzles or sprinklers of the water extinguishing system. Water or water with extinguishing agent additives, such as foam or wetting agents, is used as the extinguishing fluid. Water extinguishing systems are therefore understood here to mean all extinguishing systems that are operated using a fluid extinguishing agent, i.e. a liquid, gaseous or mixed form thereof.

Regular checks and maintenance are required to keep such water extinguishing systems in a state of operational readiness. For example, the VdS 2212 guideline requires the system operator to conduct weekly checks on the water extinguishing system.

Since reliable starting of the pump delivering the extinguishing fluid is required for the functioning of the extinguishing system, the tests also include a pump test run.

Such pump test runs serve to check the functionality of the entire chain of components in their interaction, from the generation of a pressure drop, to the correct functioning of the pressure switching apparatus, to the starting of the sprinkler pump or pumps. For this purpose, the pump test run must continue until the normal operating parameters of the pump are reached.

Sprinkler pumps are usually centrifugal pumps, especially those configured as volute casing pumps. Centrifugal pumps, also known as dynamic pumps, are a type of pump that uses a rotating impeller to generate a flow of extinguishing fluid. This is achieved by increasing the speed of the extinguishing fluid. These pumps work by generating a continuous flow that moves a liquid, in particular the extinguishing fluid, from the suction side to the discharge side of the pump.

The pump housing of the sprinkler pump regularly includes a wet chamber in which the rotating impeller moves the extinguishing fluid from the suction side to the discharge side of the pump. The impeller is made to rotate by the drive, which is mechanically coupled to the drive shaft of the sprinkler pump. The drive is a diesel engine or an electric motor, for example.

The drive shaft of the sprinkler pump extends in particular from the impeller in the wet chamber of the pump housing, via a dry chamber, which may be surrounded by a bearing housing, for example, and comprises bearings for guiding the drive shaft, to the drive. This bearing housing is connected to the pump housing in particular.

The drive shaft must be sealed against the pump housing. A gland packing is an economical sealing solution. For example, a packing cord such as a PTFE cord, a felt cord, an impregnated cotton cord or a graphite cord is used as the sealing material, the packing cord being wrapped around the shaft and pressed into a chamber. If it appears that the leakage rate is increasing—for example due to wear or other influencing factors—it is necessary to actuate an adjusting element, such as a press plunger or a press flange, in order to readjust the sealing effect of the gland. If this is no longer possible, a new packing cord is inserted. The gland is a sealing element that always has a certain amount of leakage.

The gland packing is therefore configured for the passage of leakage fluid from the pump housing into a dry chamber. The leakage fluid on the one hand cools the sealing material and on the other hand serves as a lubricant and/or slip agent. Ideally, this passage of leakage fluid only involves small quantities of leakage fluid. In particular, when the sprinkler pump is started up, the leakage fluid flow is adjusted with the adjusting element so that a certain amount of leakage fluid always passes through.

The leakage fluid comprises, in particular, water, aqueous extinguishing agents or other common extinguishing agents. Where the term leakage fluid is used below, it can also refer to any fluid, in particular leakage water.

For example, the NFPA25 standard stipulates a minimum leakage fluid quantity of one drop per second, which must not be fallen below.

This leakage fluid quantity is regularly assessed visually during the regular pump test run, for example by counting the number of drops per unit of time.

Solutions are also known in the prior art which automatically report increased leakages or indicate when a predefined maximum leakage fluid quantity is exceeded.

DE 2 617 658 A1, for example, discloses a gland packing with a monitoring or control system connected therewith that has devices which detect or identify leaks in the seals arranged around a polished piston rod and which correct or eliminate the leaks by adjusting or shifting these seals. A pressure-actuated piston system is provided for pressing these seals against the polished rod. Additional devices are also provided to report leaks to the operating personnel.

DE 10 2019 135 815 B3 discloses a water extinguishing system with monitoring of at least one parameter value of a parameter indicative of the cross-section of a fluid bypass line. This parameter value is also used to control the pump test run of a sprinkler pump.

A further disadvantage of known water extinguishing systems is that the amount of leakage fluid must be assessed visually during the pump test run. In particular, a suitably trained person must be present on site to carry out monitoring during such a pump test run. Performing such a pump test run is therefore very labour-intensive. Moreover, a purely visual assessment of the amount of leakage fluid is prone to errors and relatively inaccurate.

A disadvantage of known monitoring apparatuses for leaks in gland packings is that only such malfunctions of the gland packing are detected that lead to increased leakage rates up to a thoroughly leaking gland.

It is therefore an object of the present disclosure to propose a monitoring apparatus which allows for precise and reliable detection of the leakage fluid, in particular of small quantities. It is furthermore an object of the present disclosure to detect and effectively prevent possible damage to and/or destruction of the gland packing due to insufficient lubrication and/or insufficient cooling as early as possible. Another object is to detect the leakage fluid automatically and as cost-effectively as possible. It is also an object of the present disclosure to provide a corresponding monitoring method. A further task is to provide a water extinguishing system with such a monitoring apparatus.

### SUMMARY

The object is achieved by a monitoring apparatus for a pump test run with the features mentioned at the outset, in that the monitoring apparatus comprises a measuring unit adapted to detect the leakage fluid passing through the gland packing from the pump housing into the dry chamber during the pump test run, and is configured to generate a stop signal to switch off the sprinkler pump and/or an alarm signal if the flow rate falls below a predefined minimum.

This ensures, for the first time, that falling below the predefined minimum flow rate is detected automatically and reliably. Damage that might otherwise be caused to the gland packing is thus always avoided, and corrective measures can be taken. This ensures that the predefined minimum flow rate of leakage fluid is guaranteed during each pump test run and that wear and damage to the gland packing due to insufficient lubrication and/or insufficient cooling is always avoided.

Maintaining the predefined minimum flow rate protects the gland packing from increased frictional forces and the resulting induced heat effect on the gland. This has the aspect of extending the service life of the gland packing. It guarantees that the gland packing will retain its sealing properties for as long as possible. In the event of an undesired loss of function of the gland packing, large quantities of leakage fluid will regularly escape, resulting in such a sharp drop in pressure that a sufficient supply of extinguishing fluid to the sprinklers/nozzles would no longer be guaranteed, thereby jeopardizing the overall extinguishing process. The reliable functioning of the gland packing is therefore guaranteed, in particular when the sprinkler pump is started in case of fire.

In some embodiments, the measuring unit is also configured and adapted to detect the minimum flow rate quantitatively or qualitatively. Quantitative detection includes, for example, volumetric determination of the minimum flow rate. The qualitative detection system is adapted, for example, to detect the minimum flow rate optically, for example by of optical sensors or a camera. In some embodiments, the optical detection system involves drop detection, comparison with a predefined threshold value or water jet detection. In some embodiments, the measuring unit is configured to detect very small leaks.

Optionally, values can be defined for the amount of leakage fluid. If, for example, one drop of leakage fluid is assumed to have a value of 0.05 ml, for a predefined minimum flow rate of leakage fluid of one drop per second this results in a volume flow value of 0.05 ml/s.

An expedient embodiment of the monitoring apparatus is characterised in that the monitoring apparatus also has a control unit, the control unit being connected to the measuring unit and the drive in a signal-conducting manner, the control unit or the measuring unit being configured and adapted to generate the alarm signal and/or the stop signal to switch off the sprinkler pump.

In some embodiments, the control unit starts the pump test run and generates the alarm signal and/or the stop signal to switch off the sprinkler pump. In particular, the control unit controls the measuring unit and records and processes data and signals from the measuring unit.

In some embodiments, the measuring unit is selected, for example, from the following list: image processing systems, fill level measuring systems, load cells, mechanical fill level measuring devices such as floats, conductivity measuring systems, capacitive measuring systems, optical measuring systems or ultrasonic systems.

Different measured variables are thus used to determine the passage of leakage fluid and to check whether the minimum flow rate is fallen below. Detecting the passage of leakage fluid in the context of the present disclosure and checking whether the detected passage falls below the predefined minimum flow rate is understood to mean that a corresponding numerical value is assigned or assignable to the detected measured variable for determining the passage of leakage fluid. It is also possible for the minimum flow rate to be recorded in a non-quantified form, i.e. purely qualitatively.

Substitute measured variables can be recorded, such as the time taken to reach a fill level, for example when using fill level measuring systems.

The recorded numerical value of the measured variable therefore does not necessarily have to correspond to the actual volume flow values of the leakage fluid, but can be converted using a predefined assignment rule. In an aspect, the numerical value correlates with a volume flow value. In some embodiments, a numerical value is also defined for the predefined minimum flow rate.

In some embodiments, the stop signal to switch off the sprinkler pump and/or the alarm signal is generated when the predefined minimum flow rate is in the range of a volume flow of, for example, 0.01 ml per second to 0.5 ml per second, particularly in the range of 0.05 ml per second to 0.3 ml per second. If a drop of water is assumed or estimated to have a volume of 0.05 ml, the range for the predefined minimum flow rate is one to ten drops per second, particularly in the range of one to six drops per second.

A further expedient embodiment of the monitoring apparatus is characterised in that the measuring unit comprises a collecting vessel adapted to detect the leakage fluid and the measuring unit is configured to detect the leakage fluid in the collecting vessel based on at least one fill level. In some embodiments, the at least one fill level is used as a reference value or measure for determining the amount of leakage fluid. In other words, the fill level corresponds to the flow rate of the leakage fluid. In some embodiments, the measuring unit determines directly or indirectly whether the flow rate into the collecting vessel corresponds to the predefined minimum flow rate or even falls below it. The collecting vessel according to the present disclosure is configured as an accumulation vessel. This offers the aspect that even the smallest passage of leakage fluid can be detected, as the collecting vessel performs an accumulating function.

In some embodiments, the collecting vessel is arranged below a leakage fluid outlet opening of the bearing housing. The leakage fluid thus passes from the wet chamber of the pump housing into the dry chamber of the bearing housing and, in some embodiments, via the leakage fluid outlet opening into the collecting vessel.

According to an alternative configuration of the collecting vessel, this is part of a two-armed lever that is pivotable about a pivot axis. If the leakage fluid entering the collecting vessel exceeds a predefined quantity, a tilting moment is automatically generated so that the collecting vessel empties on its own accord and the tilting of the collecting vessel is used to detect the leakage.

A further expedient embodiment of the monitoring apparatus is characterised in that the measuring unit or the control unit is adapted to generate the alarm signal and/or the stop signal to switch off the sprinkler pump if, during an initial filling of the collecting vessel, the at least one fill level of the leakage fluid in the collecting vessel is not reached within a predefined initial filling time t₀.

After the pump test run has started, the pressure build-up in the pump housing causes leakage fluid to pass through the gland packing. The fluid passing through the gland packing, for example water, travels as leakage fluid from the wet chamber of the pump housing into the dry chamber of the bearing housing. It takes a certain time to accumulate there, depending on the surface condition and surface topology inside the bearing housing, in order to reach the collecting vessel via the leakage fluid outlet opening. This predefined initial filling time t₀ thus takes into account a dead period after the pump test is started in order to detect when the flow rate falls below the predefined minimum flow rate. In some embodiments, the predefined initial filling time t₀ is determined at the time of commissioning the sprinkler pump, or, for example, is determined independently of the commissioning process in test series for the pump type in question.

This offers the aspect that, if the leakage fluid flow rate is too low, it is reported at an early stage after detection. If the flow rate falls below the predefined minimum, the alarm signal is immediately generated and/or the sprinkler pump is switched off, so that wear and damage to the gland packing due to insufficient lubrication and/or insufficient cooling can at any rate be avoided by switching it off in good time.

In some embodiments, the measuring unit or the control unit is configured and adapted to check whether, during the initial filling of the collecting vessel, an initial filling time t_{S0} until the at least one fill level is reached satisfies a first inequality t_{S0}<t₀ and also configured and adapted, if the first inequality is satisfied, to detect filling times t_{S} until the at least one fill level is reached in further filling cycles.

If the measuring unit or the control unit has checked that the first inequality t_{S0}<t₀ is satisfied, and therefore the flow rate is not below the predefined minimum, the pump test run can continue. In some embodiments, during the pump test run, the filling times t_{S} until the at least one fill level is reached are recorded in further filling cycles to determine whether the leakage fluid has fallen below the predefined minimum flow rate.

In some embodiments of the monitoring apparatus, a shut-off element is arranged on the collecting vessel, and the measuring unit or the control unit is configured and adapted to open the shut-off element to drain the accumulated leakage fluid when the at least one fill level is reached and then to close it, and to detect a filling cycle time t_{Z} between two successive fillings of the collecting vessel until the at least one fill level is reached again, and to generate the alarm signal and/or the stop signal to switch off the sprinkler pump if t_{Z} satisfies a second inequality t_{Z}>t₁ where t₁ is a predefined filling cycle time.

This ensures that the accumulated leakage fluid is drained regularly, thereby preventing overfilling and emptying the collecting vessel in order to allow leakage fluid to accumulate again so that flow rate detection can be repeated. This offers the aspect that small quantities of leakage fluid are detected quasi-continuously or repeatedly, thus ensuring that detection of a shortfall below the predefined minimum flow rate is always guaranteed. In other words, the shut-off element ensures that, for example, the at least one fill level must be reached repeatedly and that it is not exceeded permanently or for a long period of time.

Alternatively, the shut-off element is configured in particular to be free of dead space. Optionally, the shut-off element is arranged in the floor of the collecting vessel and is adapted to open an aperture in the receptacle in a controllable manner. This particularly favours the detection of low leakage.

In some embodiments, the shut-off element is optionally configured as a valve, particularly as a solenoid valve. This offers the aspect that the leakage fluid is kept in the collecting vessel in a controllable manner and can be drained in a controlled and precise way if required.

In some embodiments, the filling cycle time t_{Z} satisfies the equation t_{Z}=t_{S}+t_{A}, where t_{A} is a predefined drain time between opening and closing the shut-off element to drain the accumulated leakage fluid. The time t_{S} is the filling time t_{S} until the at least one fill level is reached. The values for t₀ and/or t₁ are stored in the measuring unit or the control unit, for example, before or during commissioning of the monitoring apparatus.

In some embodiments, a float adapted to detect the leakage fluid is movably arranged in the collecting vessel and the measuring unit is configured to detect the at least one fill level based on the position of the float. In some embodiments, the monitoring apparatus according to the present disclosure has the simplest possible design and is extremely reliable and low-maintenance due to its low mechanical complexity.

In some embodiments, the measuring unit comprises a position determination device adapted to detect at least one position of the float. The position determination device is adapted to detect when the float reaches the at least one fill level in the collecting vessel. This makes it possible to deduce the flow rate based on the at least one fill level.

In some embodiments, the position determination device comprises at least one reed contact arranged on the collecting vessel and at least one magnetic element connected to the float, or the float formed from a magnetic material. This represents a cost-effective design. Furthermore, the operating costs of such a solution are extremely low.

In some embodiments, the control unit is connected to the at least one reed contact in a signal-conducting manner, and the measuring unit or the control unit is also configured and adapted to detect the initial filling time t_{S0} and the filling cycle times t_{Z} when the switching state of the at least one reed contact is changed by the magnetic element of the float, or by the float made of a magnetic material, when the at least one fill level is reached.

In some embodiments, the monitoring apparatus is configured to check, after the pump test run is started, and before the sprinkler pump drive is started, whether an idle state signal is present within a predefined warning time and to generate a warning signal if the predefined warning time is exceeded without the idle state signal being detected, the idle state signal representing a state of operational readiness of the measuring unit. This has the aspect that, if elements of the measuring unit are defective or not in a functional condition, these faults can be rectified before the sprinkler pump is started without a functional monitoring apparatus.

In some embodiments, the position determination device comprises only one reed contact, which is arranged on the collecting vessel in such a way that the reed contact is closed when the vessel is empty. When the at least one fill level is reached, the reed contact is opened. In some embodiments, the monitoring apparatus is configured so that the open reed contact is detected by the control unit or the measuring unit as a switching signal, also referred to below as the filling switching signal, and the filling cycle time t_{Z} is determined from the time difference between two successive filling switching signals. In some embodiments, the monitoring apparatus is further configured and adapted so that the closed reed contact is detected as an idle state signal when the collecting vessel is empty.

In some embodiments, if the idle state signal is absent within a predefined warning time, the monitoring apparatus is adapted to detect this as a fault and generate a stop signal to switch off the sprinkler pump. In particular, the monitoring apparatus is configured to open the shut-off element for the drain time t_{A} before the initial filling of the collecting vessel after the pump test run is started. The system is ready for operation when the shut-off element is closed again and a new filling cycle can start. This makes it possible to create defined starting conditions for detecting the leakage fluid.

In some embodiments, an absent idle state signal within the predefined warning time is detected as a fault if the shut-off element or the reed contact is defective or the float has become jammed in the collecting vessel. This is a cost-effective and reliable way of monitoring the functionality of the monitoring apparatus.

In some embodiments, the float is configured with an interior enclosed on all sides, in which the at least one magnetic element is arranged. This prevents the at least one magnetic element from coming into contact with the leakage fluid, thus preventing otherwise possible corrosion of the at least one magnetic element. In some embodiments, the interior is configured such that the float has a lower overall density than the leakage fluid. The material of the float is always chosen so that the weight force is less than the buoyancy force.

In some embodiments, the float is solid or hollow and has a cylindrical, spherical, hemispherical, cube or cuboid shape. The hollow form of the float has the aspect, for example, that the interior of the float is sealed off from the leakage fluid. In some embodiments, the shape of the float corresponds to the cross-sectional geometry of the collecting vessel.

In some embodiments, the float is formed of at least two parts and comprises a lid element and a base element, the lid element and the base element being configured in such a way that they form the interior when joined together. For the float variant with the at least one magnetic element, this has the aspect that the at least one magnetic element can be inserted with little effort before the lid element and the base element are joined together.

In some embodiments, the lid element and the base element can be fitted together, with a form-fitting, force-fitting and/or materially bonded connection, and, when fitted together, form the interior and/or the cavity.

In some embodiments, the interior is formed by a recess that extends at least partially in the lid element and/or in the base element. In some embodiments, the float has a reduced overall density due to the cavity-creating recess, thus favouring its buoyancy. In particular, the cavity is filled with air.

In some embodiments, the lid element has a fluid-draining surface topology on the side facing away from the base element. For example, at least part of the surface of the lid element can be conical or pyramid-shaped, with the tip aligned in the direction of the buoyancy force. Furthermore, at least part of the surface of the lid element can be paraboloid, convex or hemispherical. This allows for a better distribution of the collected leakage fluid in the collecting vessel and a delay-free flow past the outer walls of the float. In some embodiments, this raised material surface of the lid element prevents small amounts of leakage fluid from being deposited and/or accumulating on the surface. It should also reduce the contact time between the leakage fluid and the surface. Optionally, the surface can be coated with a hydrophobic material, for example with a “lotus effect” coating. To reduce adhesive forces, the contact surface is desirable kept to a minimum. In other words, the surface should be minimally wetted by the leakage fluid.

In some embodiments, the float has an upper side and an underside. The upper side is the side of the lid element facing away from the base element in the direction of the buoyancy force. The underside is the side of the base element facing away from the lid element and opposite to the direction of the buoyancy force.

In some embodiments, the fluid-draining surface topology of the lid element is arranged on the upper side of the float.

In some embodiments, the base element has at least one spacer element on the side facing away from the lid element, which ensures the flow of leakage fluid between a support element of the collecting vessel and the base element.

The support element is the element on which the float rests with a support surface on the lower outer side of the base element when the accumulated leakage fluid has been drained. In some embodiments, the support surface is located on the underside of the float. In some embodiments, a plurality of spacer elements form channels open on one side, which extend over the entire cross-section of the base element of the float.

In some embodiments, the at least one spacer element is arranged on the underside of the float. In some embodiments, a plurality of spacer elements are arranged on the underside.

In some embodiments, the float has a through-recess extending from the lid element to the base element. This enables faster, unhindered distribution of the collected leakage fluid in the collecting vessel, as the leakage fluid can also flow through the through-recess.

A further expedient embodiment of the monitoring apparatus is characterised in that the cross-sectional geometry of the collecting vessel is at least substantially similar to the cross-sectional geometry of the outer walls of the float, so that the outer walls of the float are spaced on all sides from the inner walls or inner wall of the collecting vessel, while maintaining a minimum distance from one another. In some embodiments, the volume of the intermediate space between the float and the inner wall of the collecting vessel is as small as possible, so that the float floats reliably even with very small leakage quantities.

Thus for example the collecting vessel is configured as a tube made for example of transparent material, such as PVC. In some embodiments, the inner diameter of the tube is 1 to 4 mm larger or 2 mm larger than the outer diameter of the—for example cylindrical—float. The configuration of the float as a hollow cylinder, or as a float with a through-recess, allows the leakage fluid to fill the collecting vessel with minimal hindrance and reduces the influence of surface tension effects. This ensures reliable and reproducible time measurement of the initial filling time t_{S0} and the filling cycle time t_{Z}.

A first groove-like recess, which in some embodiments is configured as an open groove in the direction of the outer casing of the hollow cylindrical base element, and a second groove-like recess in the base element, which in some embodiments is configured as an open groove in the direction of the through-recess in the hollow cylindrical base element, are arranged in the lid element. In some embodiments, the first groove-like recess and the second groove-like recess form the interior when the lid element and base element are fitted together.

The object is further achieved by a method for monitoring a pump test run of a sprinkler pump with the features mentioned at the outset by the following method steps:
Detection of the leakage fluid passing from the pump housing via the gland packing into the dry chamber during the pump test run by a measuring unit of a monitoring apparatus.
Generation of an alarm signal and/or a stop signal to switch off the sprinkler pump if the flow rate falls below a predefined minimum.

The aspects achieved with the method according to the present disclosure correspond to the aspects mentioned above with the monitoring apparatus according to the present disclosure. Therefore, in order to avoid repetition, only selected aspects of the method according to the present disclosure will be discussed in more detail here and in the following; otherwise, the aspects and explanations given above in connection with the monitoring apparatus according to the present disclosure also apply analogously to the method according to the present disclosure.

In some embodiments, the method is carried out using the monitoring apparatus according to the present disclosure.

In some embodiments, the monitoring apparatus also has a control unit, the control unit being connected to the measuring unit and the drive in a signal-conducting manner, the generation of the alarm signal and/or the stop signal to switch off the sprinkler pump taking place by the control unit or the measuring unit.

In some embodiments, the monitoring apparatus checks, after the pump test run is started, and before the sprinkler pump drive is started, whether an idle state signal is present within a predefined warning time, and generates a warning signal if the predefined warning time is exceeded without the idle state signal being detected, the idle state signal representing a state of operational readiness of the measuring unit.

This has the aspects that, if one or more components of the measuring unit are defective or not in a functional condition, these faults can be rectified before the sprinkler pump is started without a functional monitoring apparatus.

A further expedient embodiment of the present disclosure is characterised by the further method step:
Detection of the leakage fluid in a collecting vessel based on at least one fill level of the leakage fluid in the collecting vessel by the measuring unit.

In some embodiments, the alarm signal and/or the stop signal to switch off the sprinkler pump is generated by the control unit or the measuring unit if, during an initial filling of the collecting vessel, the at least one fill level of the leakage fluid in the collecting vessel is not reached within a predefined initial filling time t₀.

In some embodiments, the method is characterised by the further method steps during the initial filling of the collecting vessel:
Checking by the measuring unit or the control unit whether an initial filling time t_{S0} until the at least one fill level is reached satisfies a first inequality t_{S0}<t₀ and
Detection of filling times t_{S} until the at least one fill level is reached in further filling cycles when the first inequality is satisfied, by the measuring unit or the control unit.

After the pump test run has started, due to the build-up of pressure in the pump housing, leakage fluid begins to pass through the gland packing. The water passing through the gland packing travels as leakage fluid from the wet chamber of the pump housing into the dry chamber of the bearing housing. It takes a certain time to accumulate there, depending on the surface condition and surface topology inside the bearing housing, in order to reach the collecting vessel via a leakage fluid outlet opening. This predefined initial filling time t₀ thus takes into account a dead period after the pump test is started in order to detect when the flow rate falls below the predefined minimum flow rate. In some embodiments, this predefined initial filling time t₀ is determined at the time of commissioning the sprinkler pump, or is determined independently of the commissioning process in test series, for the pump type in question.

If the measuring unit or the control unit has checked that the first inequality t_{S0}<t₀ is satisfied, and therefore the flow rate is not below the predefined minimum, the pump test run can continue. In some embodiments, during the pump test run, the filling times t_{S} until the at least one fill level is reached are recorded in further filling cycles to determine whether the leakage fluid has fallen below the predefined minimum flow rate.

A further expedient embodiment of the method is characterised by the further method steps carried out by the measuring unit or the control unit:
Opening of a shut-off element arranged on the collecting vessel in order to drain the accumulated leakage fluid when the at least one fill level is reached.
Closing of the shut-off element.
Detection of a filling cycle time t_{Z} between two successive fillings of the collecting vessel until the at least one fill level is reached again.
Generation of the alarm signal and/or the stop signal to switch off the sprinkler pump when t_{Z} satisfies a second inequality t_{Z}>t₁ where t₁ is a predefined filling cycle time.

According to a second expedient embodiment of the method, the filling cycle time t_{Z} satisfies the equation t_{Z}=t_{S}+t_{A}, where t_{A} is a predefined drain time between opening and closing the shut-off element to drain the accumulated leakage fluid.

In some embodiments, the method also comprises the further method steps:
Detection of the leakage fluid with a float movably arranged in the collecting vessel.
Detection of the at least one fill level based on the position of the float by the measuring unit.
Determination of at least one position of the float by a position determination device.

In some embodiments, a further method step of the method is the detection of the initial filling time t_{S0} and the filling cycle time t_{Z} when a switching state of at least one reed contact changes, the position determination device being formed by the at least one reed contact arranged on the collecting vessel and at least one magnetic element connected to the float, or by the at least one reed contact arranged on the collecting vessel and a float made of a magnetic material.

In some embodiments, a float according to the present disclosure of the float is used in the method according to the present disclosure.

In some embodiments, the initial filling time t_{S0}, the filling time t_{S} or the filling cycle time t_{Z} is detected by the position determination device.

The object is further achieved by the water extinguishing system mentioned at the outset, which disposes of the above-described monitoring apparatus according to the present disclosure.

The present disclosure also relates to a monitoring apparatus and a method for monitoring a pump.

Pumps with gland packings for delivering fluids also have to be monitored in other applications.

The pump housing of the pump usually includes a wet chamber in which the rotating impeller moves the fluid to be delivered from the suction side to the discharge side of the pump. The impeller is made to rotate by the drive, which is mechanically coupled to the drive shaft of the pump. The drive is a diesel engine or an electric motor, for example.

The drive shaft of the pump extends in particular from the impeller in the wet chamber of the pump housing, via a dry chamber, which can be surrounded by a bearing housing, for example, and, in some embodiments, comprises bearings for guiding the drive shaft, to the drive. This bearing housing is connected to the pump housing in particular.

The drive shaft must be sealed against the pump housing. A gland packing is an economical sealing solution. For example, a packing cord such as a PTFE cord, a felt cord, an impregnated cotton cord or a graphite cord is used as the sealing material, the packing cord being wrapped around the shaft and pressed into a chamber. If it appears that the leakage rate is increasing—for example due to wear or other influencing factors—it is necessary to actuate an adjusting element, such as a press plunger or a press flange, in order to readjust the sealing effect of the gland. If this is no longer possible, a new packing cord is inserted. The gland is a sealing element that always has a certain amount of leakage.

The gland packing is therefore configured for the passage of leakage fluid from the pump housing into a dry chamber. The leakage fluid on the one hand cools the sealing material and on the other hand serves as a lubricant and/or slip agent. Ideally, this passage of leakage fluid should only involve small quantities of leakage fluid. In particular, when the pump is started up, the passage of leakage fluid is adjusted with the adjusting element so that a certain amount of leakage fluid always passes through.

Where the term leakage fluid is used below, it can always refer to any fluid.

Solutions are known in the prior art which automatically report increased leakages or indicate when a predefined maximum leakage fluid quantity is exceeded.

DE 2 617 658 A1, for example, discloses a gland packing with a monitoring or control system connected therewith that has devices which detect or identify leaks in the seals arranged around a polished piston rod and which correct or eliminate the leaks by adjusting or shifting these seals. A pressure-actuated piston system is provided for pressing these seals against the polished rod. Additional devices are also provided to report leaks to the operating personnel.

It is therefore a further object of the present disclosure to propose a monitoring apparatus for a pump which permits precise and reliable detection of the leakage fluid, in particular of small quantities. It is furthermore an object of the present disclosure to detect and effectively prevent possible damage to and/or destruction of the gland packing due to insufficient lubrication and/or insufficient cooling as early as possible. Another task is to detect the leakage fluid automatically and as cost-effectively as possible. It is also the task of the present disclosure to provide a corresponding monitoring method.

This object is achieved by a monitoring apparatus for a pump with the features mentioned at the outset for the third feature of the present disclosure, in that the monitoring apparatus comprises a measuring unit adapted to detect the leakage fluid passing through the gland packing from the pump housing into the dry chamber during the pump run, and is configured to generate a stop signal to switch off the pump and/or an alarm signal if the flow rate falls below a predefined minimum.

This is the monitoring apparatus according to the third aspect of the present disclosure with the following embodiments.

This ensures, for the first time, that falling below the predefined minimum flow rate is detected automatically and reliably. Damage that might otherwise be caused to the gland packing is thus always avoided and corrective measures can be taken. This ensures that the predefined minimum flow rate of leakage fluid is guaranteed during each pump run and that wear and damage to the gland packing due to insufficient lubrication and/or insufficient cooling is always avoided.

Maintaining the predefined minimum flow rate protects the gland packing from increased frictional forces and the resulting induced heat effect on the gland. This has the aspect of extending the service life of the gland packing. It guarantees that the gland packing will retain its sealing properties for as long as possible. In the event of an undesired loss of function of the gland packing, large quantities of leakage fluid will regularly escape, resulting in such a sharp drop in pressure that a sufficient supply of the fluid to be delivered would no longer be guaranteed.

In some embodiments, the measuring unit is also configured and adapted to detect the minimum flow rate quantitatively or qualitatively. Quantitative detection includes, for example, volumetric determination of the minimum flow rate. The qualitative detection system is adapted, for example, to detect the minimum flow rate optically, for example by optical sensors or a camera. In some embodiments, the optical detection system involves drop detection, comparison with a predefined threshold value or fluid jet detection. In some embodiments, the measuring unit is configured to detect very small leaks.

Optionally, values can be defined for the amount of leakage fluid. If, for example, one drop of leakage fluid is assumed to have a value of 0.05 ml, for a predefined minimum flow rate of leakage fluid of one drop per second this results in a volume flow value of 0.05 ml/s.

An expedient embodiment of the monitoring apparatus is characterised in that the monitoring apparatus also has a control unit, the control unit being connected to the measuring unit and the drive in a signal-conducting manner, the control unit or the measuring unit being configured and adapted to generate the alarm signal and/or the stop signal to switch off the pump.

In some embodiments, the control unit starts the pump run and generates the alarm signal and/or the stop signal to switch off the pump. In particular, the control unit controls the measuring unit and records and processes data and signals from the measuring unit.

In some embodiments, the measuring unit is selected, for example, from the following list: image processing systems, fill level measuring systems, load cells, mechanical fill level measuring devices such as floats, conductivity measuring systems, capacitive measuring systems, optical measuring systems or ultrasonic systems.

Different measured variables are thus used to determine the passage of leakage fluid and to check whether the minimum flow rate is fallen below. In some embodiments, detecting the passage of leakage fluid in the context of the present disclosure and checking whether the detected passage falls below the predefined minimum flow rate is understood to mean that a corresponding numerical value is assigned or assignable to the detected measured variable for determining the passage of leakage fluid. It is also possible for the minimum flow rate to be recorded in a non-quantified form, i.e. purely qualitatively.

Substitute measured variables can be recorded, such as the time taken to reach a fill level, for example when using fill level measuring systems.

The recorded numerical value of the measured variable therefore does not necessarily have to correspond to the actual volume flow values of the leakage fluid, but can be converted using a predefined assignment rule. In some embodiments, the numerical value correlates with a volume flow value. In some embodiments, a numerical value is also defined for the predefined minimum flow rate.

In some embodiments, the stop signal to switch off the pump and/or the alarm signal is generated when the predefined minimum flow rate is in the range of a volume flow of, for example, 0.01 ml per second to 0.5 ml per second or in the range of 0.05 ml per second to 0.3 ml per second. In some embodiments, if a drop of fluid is assumed or estimated to have a volume of 0.05 ml, the range for the predefined minimum flow rate is one to ten drops per second or in the range of one to six drops per second.

A further expedient embodiment of the monitoring apparatus is characterised in that the measuring unit comprises a collecting vessel adapted to detect the leakage fluid and the measuring unit is configured to detect the leakage fluid in the collecting vessel based on at least one fill level. In some embodiments, the at least one fill level is used as a reference value or measure for determining the amount of leakage fluid. In other words, the fill level corresponds to the flow rate of the leakage fluid. In some embodiments, the measuring unit determines directly or indirectly whether the flow rate into the collecting vessel corresponds to the predefined minimum flow rate or even falls below it. In some embodiments, the collecting vessel according to the present disclosure is configured as an accumulation vessel. This offers the aspect that even the smallest passage of leakage fluid can be detected, as the collecting vessel performs an accumulating function.

In some embodiments, the collecting vessel is arranged below a leakage fluid outlet opening of the bearing housing. In some embodiments, the leakage fluid thus passes from the wet chamber of the pump housing into the dry chamber of the bearing housing and via the leakage fluid outlet opening into the collecting vessel.

According to an alternative configuration of the collecting vessel, this is part of a two-armed lever that is pivotable about a pivot axis. If the leakage fluid entering the collecting vessel exceeds a predefined quantity, a tilting moment is automatically generated so that the collecting vessel empties on its own accord and the tilting of the collecting vessel is used to detect the leakage.

A further expedient embodiment of the monitoring apparatus is characterised in that the measuring unit or the control unit is adapted to generate the alarm signal and/or the stop signal to switch off the pump if, during an initial filling of the collecting vessel, the at least one fill level of the leakage fluid in the collecting vessel is not reached within a predefined initial filling time t₀.

After the pump run has started, the pressure build-up in the pump housing causes leakage fluid to pass through the gland packing. The fluid passing through the gland packing travels as leakage fluid from the wet chamber of the pump housing into the dry chamber of the bearing housing. It takes a certain time to accumulate there, depending on the surface condition and surface topology inside the bearing housing, in order to reach the collecting vessel via the leakage fluid outlet opening. This predefined initial filling time t₀ therefore takes into account a dead period after the pump is started to detect when the flow rate falls below the predefined minimum. In some embodiments, the predefined initial filling time t₀ is determined at the time of commissioning the pump, or, for example, is determined independently of the commissioning process in test series for the pump type in question.

This offers the aspect that, if the leakage fluid flow rate is too low, it is reported at an early stage after detection. If the flow rate falls below the predefined minimum, the alarm signal is immediately generated and/or the pump is switched off, so that wear and damage to the gland packing due to insufficient lubrication and/or insufficient cooling can at any rate be avoided by switching it off in good time.

In some embodiments, the measuring unit or the control unit is configured and adapted to check whether, during the initial filling of the collecting vessel, an initial filling time t_{S0} until the at least one fill level is reached satisfies a first inequality t_{S0}<t₀ and also configured and adapted, if the first inequality is satisfied, to detect filling times t_{S} until the at least one fill level is reached in further filling cycles.

If the measuring unit or the control unit has checked that the first inequality t_{S0}<t₀ is satisfied, and therefore the flow rate is not below the predefined minimum, the pump run can continue.

In some embodiments, during the pump run, the filling times t_{S} until the at least one fill level is reached are recorded in further filling cycles to determine whether the leakage fluid has fallen below the predefined minimum flow rate.

In some embodiments, a shut-off element is arranged on the collecting vessel, and the measuring unit or the control unit is configured and adapted to open the shut-off element to drain the accumulated leakage fluid when the minimum fill level is reached and then to close it, and to detect a filling cycle time t_{Z} between two successive fillings of the collecting vessel until the at least one fill level is reached again, and to generate the alarm signal and/or the stop signal to switch off the pump if t_{Z} satisfies a second inequality t_{Z}>t₁ where t₁ is a predefined filling cycle time.

This ensures that the accumulated leakage fluid is drained regularly, thereby preventing overfilling and emptying the collecting vessel in order to allow leakage fluid to accumulate again so that flow rate detection can be repeated. This offers the aspect that small quantities of leakage fluid are detected quasi-continuously or repeatedly, thus ensuring that detection of a shortfall below the predefined minimum flow rate is always guaranteed. In other words, the shut-off element ensures that, for example, the at least one fill level must be reached repeatedly and that it is not exceeded permanently or for a long period of time.

Alternatively, the shut-off element is configured in particular to be free of dead space. Optionally, the shut-off element is arranged in the floor of the collecting vessel and is adapted to open an aperture in the receptacle in a controllable manner. This particularly favours the detection of low leakage.

The shut-off element is optionally configured as a valve, in some embodiments as a solenoid valve. This offers the aspect that the leakage fluid is kept in the collecting vessel in a controllable manner and can be drained in a controlled and precise way if required.

In some embodiments, the filling cycle time t_{Z} satisfies the equation t_{Z}=t_{S}+t_{A}, where t_{A} is a predefined drain time between opening and closing the shut-off element to drain the accumulated leakage fluid. The time t_{S} is the filling time t_{S} until the at least one fill level is reached. The values for t₀ and/or t₁ are stored in the measuring unit or the control unit, for example, before or during commissioning of the monitoring apparatus.

In some embodiments, a float adapted to detect the leakage fluid is movably arranged in the collecting vessel and the measuring unit is configured to detect the at least one fill level based on the position of the float. In some embodiments, the monitoring apparatus according to the present disclosure has the simplest possible design and is extremely reliable and low-maintenance due to its low mechanical complexity.

In some embodiments, the measuring unit comprises a position determination device adapted to detect at least one position of the float. The position determination device is adapted to detect when the float reaches the at least one fill level in the collecting vessel. This makes it possible to deduce the flow rate based on the at least one fill level.

In some embodiments, the position determination device comprises at least one reed contact arranged on the collecting vessel and at least one magnetic element connected to the float, or the float formed from a magnetic material. This represents a cost-effective design. Furthermore, the operating costs of such a solution are extremely low.

In some embodiments, the control unit is connected to the at least one reed contact in a signal-conducting manner, and the measuring unit or the control unit is also configured and adapted to detect the initial filling time t_{S0} and the filling cycle times t_{Z} when the switching state of the at least one reed contact is changed by the magnetic element of the float, or by the float made of a magnetic material, when the at least one fill level is reached.

In some embodiments, the monitoring apparatus is configured to check, after the pump run is started, and before the pump drive is started, whether an idle state signal is present within a predefined warning time and to generate a warning signal if the predefined warning time is exceeded without the idle state signal being detected, the idle state signal representing a state of operational readiness of the measuring unit. This has the aspect that, if elements of the measuring unit are defective or not in a functional condition, these faults can be rectified immediately after the pump is started or before the pump is started without a functional monitoring apparatus.

In some embodiments, the position determination device comprises only one reed contact, which is arranged on the collecting vessel in such a way that the reed contact is closed when the vessel is empty. When the at least one fill level is reached, the reed contact is opened. In some embodiments, the monitoring apparatus is configured so that the open reed contact is detected by the control unit or the measuring unit as a switching signal, also referred to below as the filling switching signal, and the filling cycle time t_{Z} is determined from the time difference between two successive filling switching signals. In some embodiments, the monitoring apparatus is further configured and adapted so that the closed reed contact is detected as an idle state signal when the collecting vessel is empty.

In some embodiments, if the idle state signal is absent within a predefined warning time, the monitoring apparatus is adapted to detect this as a fault and generate a stop signal to switch off the pump. In particular, the monitoring apparatus is configured to open the shut-off element for the drain time t_{A} before the initial filling of the collecting vessel after the pump run is started. The system is ready for operation when the shut-off element is closed again and a new filling cycle can start. This makes it possible to create defined starting conditions for detecting the leakage fluid.

In some embodiments, an absent idle state signal within the predefined warning time is detected as a fault if the shut-off element or the reed contact is defective or the float has become jammed in the collecting vessel. This is a cost-effective and reliable way of monitoring the functionality of the monitoring apparatus.

In the embodiments of the present disclosure, the float is configured with an interior enclosed on all sides, in which the at least one magnetic element is arranged. This prevents the at least one magnetic element from coming into contact with the leakage fluid, thus preventing otherwise possible corrosion of the at least one magnetic element. In some embodiments, the interior is configured such that the float has a lower overall density than the leakage fluid. The material of the float is always chosen so that the weight force is less than the buoyancy force.

In some embodiments, the float is solid or hollow and has a cylindrical, spherical, hemispherical, cube or cuboid shape. The hollow form of the float has the aspect, for example, that the interior of the float is sealed off from the leakage fluid. In some embodiments, the shape of the float corresponds to the cross-sectional geometry of the collecting vessel.

In some embodiments, the float is formed of at least two parts and comprises a lid element and a base element, the lid element and the base element being configured in such a way that they form the interior when joined together. For the float variant with the at least one magnetic element, this has the aspect that the at least one magnetic element can be inserted with little effort before the lid element and the base element are joined together.

In some embodiments, the lid element and the base element can be fitted together, with a form-fitting, force-fitting and/or materially bonded connection, and, when fitted together, form the interior and/or the cavity.

In some embodiments, the interior is formed by a recess that extends at least partially in the lid element and/or in the base element. In some embodiments, the float has a reduced overall density due to the cavity-creating recess, thus favouring its buoyancy. In particular, the cavity is filled with air.

In some embodiments, the lid element has a fluid-draining surface topology on the side facing away from the base element. For example, at least part of the surface of the lid element can be conical or pyramid-shaped, with the tip aligned in the direction of the buoyancy force. Furthermore, at least part of the surface of the lid element can be paraboloid, convex or hemispherical. This allows for a better distribution of the collected leakage fluid in the collecting vessel and a delay-free flow past the outer walls of the float. In an aspect, this raised material surface of the lid element prevents small amounts of leakage fluid from being deposited and/or accumulating on the surface. It should also reduce the contact time between the leakage fluid and the surface. Optionally, the surface can be coated with a hydrophobic material, for example with a “lotus effect” coating. To reduce adhesive forces, the contact surface is kept to a minimum. In other words, the surface should be minimally wetted by the leakage fluid.

In some embodiments, the float has an upper side and an underside. The upper side is the side of the lid element facing away from the base element in the direction of the buoyancy force. The underside is the side of the base element facing away from the lid element and opposite to the direction of the buoyancy force.

In some embodiments, the fluid-draining surface topology of the lid element is arranged on the upper side of the float.

In some embodiments, the base element has at least one spacer element on the side facing away from the lid element, which ensures the flow of leakage fluid between a support element of the collecting vessel and the base element.

The support element is the element on which the float rests with a support surface on the lower outer side of the base element when the accumulated leakage fluid has been drained. In some embodiments, the support surface is located on the underside of the float. In some embodiments, a plurality of spacer elements form channels open on one side, which extend over the entire cross-section of the base element of the float.

In some embodiments, the at least one spacer element is arranged on the underside of the float. In some embodiments, a plurality of spacer elements are arranged on the underside.

In some embodiments, the float has a through-recess extending from the lid element to the base element. This enables faster, unhindered distribution of the collected leakage fluid in the collecting vessel, as the leakage fluid can also flow through the through-recess.

A further expedient embodiment of the monitoring apparatus is characterised in that the cross-sectional geometry of the collecting vessel is at least substantially similar to the cross-sectional geometry of the outer walls of the float, so that the outer walls of the float are spaced on all sides from the inner walls or inner wall of the collecting vessel, while maintaining a minimum distance from one another. In some embodiments, the volume of the intermediate space between the float and the inner wall of the collecting vessel is as small as possible, so that the float floats reliably even with very small leakage quantities.

Thus for example the collecting vessel is configured as a tube made for example of transparent material, such as PVC. In some embodiments, the inner diameter of the tube is 1 to 4 mm larger or 2 mm larger than the outer diameter of the—for example cylindrical—float. The configuration of the float as a hollow cylinder, or as a float with a through-recess, allows the leakage fluid to fill the collecting vessel with minimal hindrance and reduces the influence of surface tension effects. This ensures reliable and reproducible time measurement of the initial filling time t_{S0} and the filling cycle time t_{Z}.

A first groove-like recess, which in some embodiments is configured as an open groove in the direction of the outer casing of the hollow cylindrical base element, and a second groove-like recess in the base element, which in some embodiments is configured as an open groove in the direction of the through-recess in the hollow cylindrical base element, are arranged in the lid element. In some embodiments, the first groove-like recess and the second groove-like recess form the interior when the lid element and base element are fitted together.

The object further relates to a method for monitoring a pump run of a pump, wherein the pump comprises at least one pump housing surrounding a wet chamber, a drive shaft arranged sealed against the pump housing by a gland packing, and a drive mechanically coupled to the drive shaft, the gland packing being configured and adapted for the passage of leakage fluid from the pump housing into the dry chamber, the task being solved by the following method steps.
Detection of the leakage fluid passing from the pump housing via the gland packing into the dry chamber during the pump run by a measuring unit of a monitoring apparatus.
Generation of an alarm signal and/or a stop signal to switch off the pump if the flow rate falls below a predefined minimum.

The aspects achieved with the method according to the present disclosure correspond to the aspects mentioned above with the monitoring apparatus according to the third aspect of the present disclosure. Therefore, in order to avoid repetition, only selected aspects of the method according to the present disclosure will be discussed in more detail here and in the following; otherwise, the aspects and explanations given above in connection with the monitoring apparatus according to the present disclosure also apply analogously to the method according to the present disclosure.

In some embodiments, the method is carried out using the monitoring apparatus according to the third aspect of the present disclosure.

In some embodiments, the monitoring apparatus also has a control unit, the control unit being connected to the measuring unit and the drive in a signal-conducting manner, the generation of the alarm signal and/or the stop signal to switch off the pump taking place by the control unit or the measuring unit.

In some embodiments, the monitoring apparatus checks, after the pump run is started, and before the pump drive is started, whether an idle state signal is present within a predefined warning time, and generates a warning signal if the predefined warning time is exceeded without the idle state signal being detected, the idle state signal representing a state of operational readiness of the measuring unit.

This has the aspect that, if one or more components of the measuring unit are defective or not in a functional condition, these faults can be rectified immediately after the pump is started or before the pump is started without a functional monitoring apparatus.

A further expedient embodiment of the present disclosure is characterised by the further method step:
Detection of the leakage fluid in a collecting vessel based on at least one fill level of the leakage fluid in the collecting vessel by the measuring unit.

In some embodiments, the alarm signal and/or the stop signal to switch off the pump is generated by the control unit or the measuring unit if, during an initial filling of the collecting vessel, the at least one fill level of the leakage fluid in the collecting vessel is not reached within a predefined initial filling time to.

In some embodiments, the method is characterised by the further method steps during the initial filling of the collecting vessel:
Checking by the measuring unit or the control unit whether an initial filling time t_{S0} until the at least one fill level is reached satisfies a first inequality t_{S0}<t₀ and
Detection of filling times t_{S} until the at least one fill level is reached in further filling cycles when the first inequality is satisfied, by the measuring unit or the control unit.

After the pump run has started, the pressure build-up in the pump housing causes leakage fluid to pass through the gland packing. The fluid passing through the gland packing travels as leakage fluid from the wet chamber of the pump housing into the dry chamber of the bearing housing. It takes a certain time to accumulate there, depending on the surface condition and surface topology inside the bearing housing, in order to reach the collecting vessel via a leakage fluid outlet opening. This predefined initial filling time t₀ thus takes into account a dead period after the pump is started to detect when the flow rate falls below the predefined minimum. In some embodiments, the predefined initial filling time t₀ is determined at the time of commissioning the pump, or is determined independently of the commissioning process in test series, p for the pump type in question.

If the measuring unit or the control unit has checked that the first inequality t_{S0}<t₀ is satisfied, and therefore the flow rate is not below the predefined minimum, the pump run can continue. In some embodiments, during the pump run, the filling times t_{S} until the at least one fill level is reached are recorded in further filling cycles to determine whether the leakage fluid has fallen below the predefined minimum flow rate.

A further expedient embodiment of the method is characterised by the further method steps carried out by the measuring unit or the control unit:
Opening of a shut-off element arranged on the collecting vessel in order to drain the accumulated leakage fluid when the at least one fill level is reached.
Closing of the shut-off element.
Detection of a filling cycle time t_{Z} between two successive fillings of the collecting vessel until the at least one fill level is reached again.
Generation of the alarm signal and/or the stop signal to switch off the pump when t_{Z} satisfies a second inequality t_{Z}>t₁ where t₁ is a predefined filling cycle time.

According to a second expedient embodiment of the method, the filling cycle time t_{Z} satisfies the equation t_{Z}=t_{S}+t_{A}, where t_{A} is a predefined drain time between opening and closing the shut-off element to drain the accumulated leakage fluid.

In some embodiments the method also comprises the further method steps:
Detection of the leakage fluid with a float movably arranged in the collecting vessel.
Detection of the at least one fill level based on the position of the float by the measuring unit.
Determination of at least one position of the float by a position determination device.

In some embodiments, a further method step in of the method is the detection of the initial filling time t_{S0} and the filling cycle time t_{Z} when a switching state of at least one reed contact changes, the position determination device being formed by the at least one reed contact arranged on the collecting vessel and at least one magnetic element connected to the float, or by the at least one reed contact arranged on the collecting vessel and a float made of a magnetic material.

In some embodiments, a float according to the aforementioned claims or the described embodiments of the float is used in the method according to the present disclosure.

In some embodiments, the initial filling time t_{S0}, the filling time t_{S} or the filling cycle time t_{Z} is detected by the position determination device.

### BRIEF DESCRIPTION OF THE DRAWINGS

Further useful and/or aspects features and embodiments of the present disclosure are described in the dependent claims and the description. Embodiments are explained in more detail with reference to the attached drawing. Both the monitoring unit according to the present disclosure and the method according to the present disclosure are explained with reference to the drawings. These show the following:

FIG. 1 is a schematic representation of the monitoring apparatus according to the present disclosure.

FIG. 2 is a schematic representation of the monitoring apparatus according to the present disclosure.

FIG. 3 is a schematic representation of the monitoring apparatus according to the present disclosure in an embodiment with a collecting vessel of the measuring unit.

FIG. 4 is a schematic representation of the monitoring apparatus according to the present disclosure according to a further embodiment with a float and a reed contact.

FIG. 5a is a perspective view of the float according to the present disclosure

FIG. 5b is a cross-sectional view of the float according to the present disclosure.

FIG. 5c is a further embodiment of the float according to the present disclosure.

FIG. 5d is a sectional view of the further float variant along the line of intersection B-B of FIG. 5c.

FIG. 6a is a schematic representation the measuring unit of the monitoring apparatus according to the present disclosure.

FIG. 6b is a sectional view of the measuring unit according to the present disclosure.

FIG. 6c is a sectional view of the measuring unit with the float variant from FIGS. 5c and 5d.

FIG. 7a is a block diagram showing the steps of the method according to the present disclosure and its embodiments.

FIG. 7b is another block diagram showing the steps of the method according to the present disclosure and its embodiments.

FIG. 7c is another block diagram showing the steps of the method according to the present disclosure and its embodiments.

FIG. 7d is another block diagram showing the steps of the method according to the present disclosure and its embodiments.

FIG. 7e is another block diagram showing the steps of the method according to the present disclosure and its embodiments.

FIG. 7f is another block diagram showing the steps of the method according to the present disclosure and its embodiments.

### DETAILED DESCRIPTION OF THE EMBODIMENTS

In the following figures, the reference number 2 is used both for a sprinkler pump 2 and, according to a third aspect of the present disclosure, for a pump 2. Consequently, the pump test run corresponds to the pump run according to the third aspect of the present disclosure.

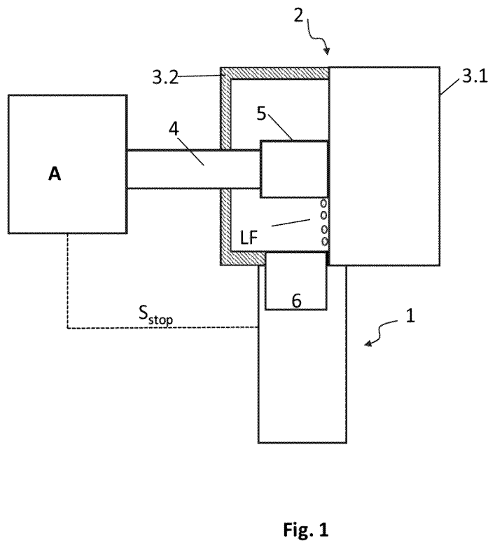

FIG. 1 shows a schematic representation of the monitoring apparatus 1 according to the present disclosure for a pump test run of a sprinkler pump 2 and a monitoring apparatus 1 for a pump 2 according to the third aspect of the present disclosure.

In all other figures, the described features of the sprinkler pump 2 are also the features of the pump 2.

The sprinkler pump 2 or the pump 2 comprises at least one pump housing 3.1 surrounding a wet chamber (not shown in the drawing), a drive shaft 4 arranged sealed against the pump housing 3.1 by a gland packing 5, and a drive A mechanically coupled to the drive shaft 4. The gland packing 5 is configured and adapted for the passage of leakage fluid LF from the pump housing 3.1, in particular from the wet chamber, into a dry chamber.

The monitoring apparatus 1 comprises a measuring unit 6 which is adapted to detect the leakage fluid LF passing from the pump housing 3.1 via the gland packing 5 into a dry chamber—not shown in the drawing—during the pump test run or during the pump run. The monitoring apparatus 1 is configured to generate a stop signal Sₛₜₒₚ to switch off the sprinkler pump 2 or the pump 2 and/or an alarm signal if the flow rate falls below a predefined minimum.

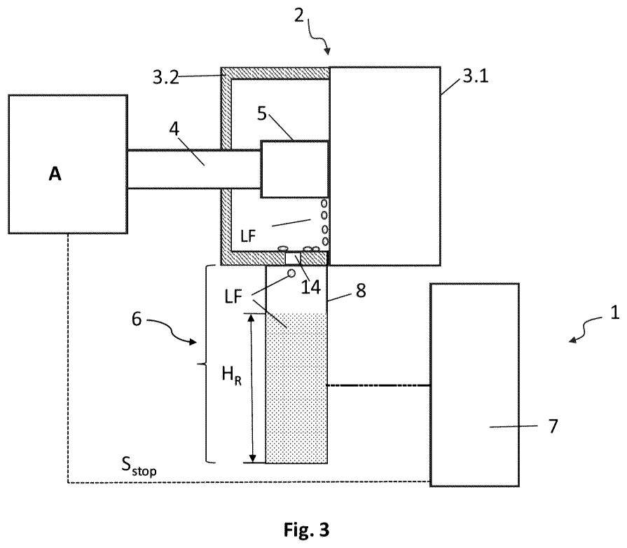

The drive shaft 4 of the sprinkler pump 2 or pump 2 in FIG. 1 extends from an impeller (not shown) in the wet chamber of the pump housing 3.1, via the dry chamber, which is surrounded by a bearing housing 3.2, for example, and comprises bearings (not shown) for guiding the drive shaft 4, to the drive A. In some embodiments, the bearing housing 3.2 is connected to the pump housing 3.1. In the base area of the bearing housing 3.2, where the leakage fluid LF that has passed through can accumulate, an opening, in some embodiments, is arranged that enables the measuring unit 6 to detect leakage fluid LF passing through. In some embodiments, the opening is configured as a leakage fluid outlet opening 14, as shown by way of example in FIG. 3. The monitoring apparatus 1 is configured to generate a stop signal Sₛₜₒₚ to switch off the sprinkler pump 2 or the pump 2 and/or an alarm signal—not shown in the drawing—if the flow rate falls below a predefined minimum.

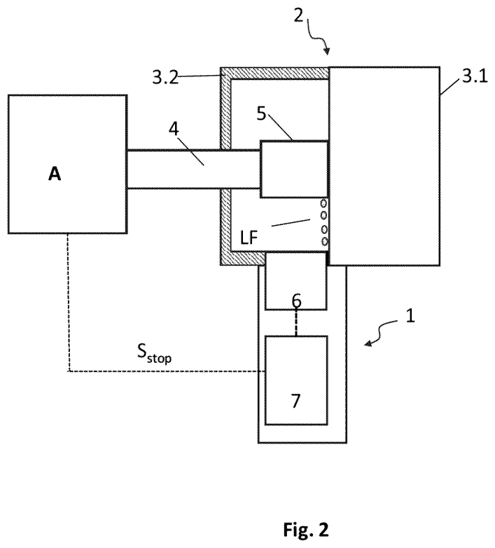

FIG. 2 is a schematic representation of an embodiment of the monitoring apparatus 1. The monitoring apparatus 1 has a control unit 7. The control unit 7 is connected to the measuring unit 6 and the drive A in a signal-conducting manner, which is shown by the dashed line. The control unit 7 is configured to generate the alarm signal and/or the stop signal Sₛₜₒₚ to switch off the sprinkler pump 2 or the pump 2. In some embodiments, the control unit 7 is configured to start the sprinkler pump 2 or the pump 2 and in some embodiments to control the pump test run or the pump run.

In a not shown embodiment of the monitoring apparatus 1, the measuring unit 6 is configured to generate the alarm signal and/or the stop signal Sₛₜₒₚ to switch off the sprinkler pump 2 or the pump 2.

A schematic representation of the monitoring apparatus 1 according to the present disclosure in an embodiment with a collecting vessel 8 of the measuring unit 6 is shown in FIG. 3. The measuring unit 6 comprises this collecting vessel 8, which is adapted to detect the leakage fluid LF. The measuring unit 6 is configured to detect the leakage fluid LF in the collecting vessel 8 based on at least one fill level H_{R}. In this embodiment too, the control unit 7 is connected to the measuring unit 6 and the drive A in a signal-conducting manner, which is shown by the dashed line. The control unit 7 receives switching signals or detected values from the measuring unit 6 via this signal-conducting connection.

In some embodiments, the alarm signal and/or the stop signal Sₛₜₒₚ to switch off the sprinkler pump 2 or the pump 2 is generated by the measuring unit 6 or the control unit 7 if, during an initial filling of the collecting vessel 8, the at least one fill level H_{R} of the leakage fluid LF in the collecting vessel 8 is not reached within a predefined initial filling time t₀.

In some embodiments, the measuring unit 6 or the control unit 7 is configured and adapted to check whether, during the initial filling of the collecting vessel 8, an initial filling time t_{S0} until the at least one fill level H_{R} is reached satisfies a first inequality t_{S0}<t₀. The measuring unit 6 or the control unit 7 are further configured and adapted, if the first inequality is satisfied, to detect filling times t_{S} until the at least one fill level H_{R} is reached in further filling cycles. This predefined initial filling time t₀ takes into account the above-mentioned dead period after the pump test is started or after the pump 2 is started in order to detect when the flow rate falls below the predefined minimum flow rate. The pump test run or the pump 2 can continue if the measuring unit 6 or the control unit 7 has checked that the first inequality t_{S0}<t₀ is satisfied, and therefore the flow rate is not below the predefined minimum flow rate. In this case, the filling times t_{S} until the at least one fill level H_{R} is reached are detected in further filling cycles.

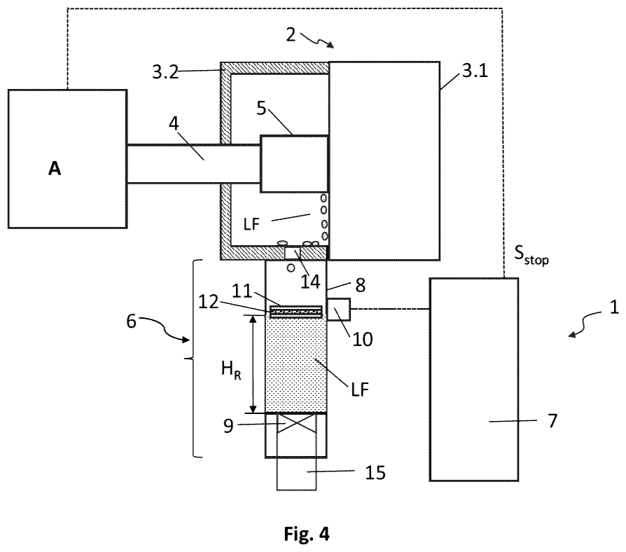

FIG. 4 schematically illustrates further embodiments of the monitoring apparatus 1 according to the present disclosure. In the first variant, the monitoring apparatus 1 is characterised in that a shut-off element 9 is arranged on the collecting vessel 8, and the measuring unit 6 or the control unit 7 is configured and adapted to open and close the shut-off element 9 to drain the accumulated leakage fluid LF when the at least one fill level H_{R} is reached, and to detect a filling cycle time t_{Z} between two successive fillings of the collecting vessel 8 until the at least one fill level H_{R} is reached again. In some embodiments, the leakage fluid LF is drained via a drain 15.

In some embodiments, the measuring unit 6 or the control unit 7 is configured and adapted to generate the alarm signal and/or the stop signal Sₛₜₒₚ to switch off the sprinkler pump 2 or the pump 2 if t_{Z} satisfies a second inequality t_{Z}>t₁ where t₁ is a predefined filling cycle time t₁. In some embodiments, the values for the predefined filling cycle time t₁ are obtained from empirical values for the corresponding sprinkler pump type or from test series during commissioning of the sprinkler pump 2 or pump 2 and are stored in the measuring unit 6 or in the control unit 7.

In some embodiments, the filling cycle time t_{Z} satisfies the equation t_{Z}=t_{S}+t_{A}, where t_{A} is a predefined drain time between opening and closing the shut-off element 9 to drain the accumulated leakage fluid LF.

In some embodiments, the values for the predefined filling cycle time t₁ are in the range of 5 to 180 seconds, in the range of 30 to 90 seconds, or in the range of 15 to 40 seconds.

Furthermore, FIG. 4 schematically shows a further version of the monitoring apparatus 1 in which a float 11 adapted to detect the leakage fluid LF is movably arranged in the collecting vessel 8. In some embodiments, the measuring unit 6 is configured to detect the at least one fill level H_{R} based on the position of the float 11.

In some embodiments, the measuring unit 6 shown in FIG. 4 comprises a position determination device—not shown in the drawing—which is adapted to determine at least one position of the float 11 and which, as shown, comprises at least one reed contact 10 arranged on the collecting vessel 8. In some embodiments, the position determination device comprises at least one magnetic element 12 connected to the float 11, or the float 11 formed from a magnetic material.

FIG. 4 also shows a further expedient configuration of the monitoring apparatus 1, which is characterised in that the control unit 7 is connected to the at least one reed contact 10 in a signal-conducting manner. In some embodiments, the measuring unit 6 or the control unit 7 is also configured and adapted to detect the initial filling time t_{S0} and the filling cycle times t_{Z} when the switching state of the at least one reed contact 10 is changed by the magnetic element 12 of the float 11, or by the float 11 made of a magnetic material, when the at least one fill level H_{R} is reached.

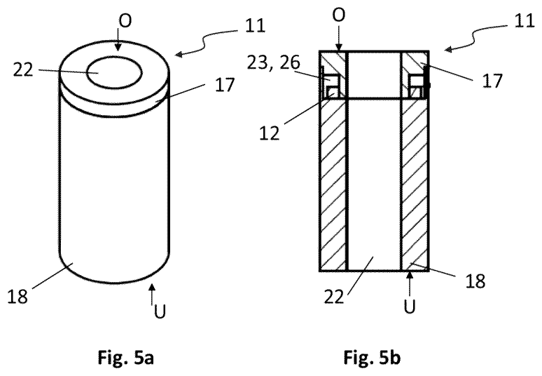

FIG. 5a and FIG. 5c show embodiments of the float 11 shown in FIG. 4, and FIGS. 5b and 5d show a sectional view of the respective embodiment of the float 11.

As FIGS. 5b and 5d show, the float 11 is configured with an interior 23 enclosed on all sides.

FIGS. 5b and 5d show schematically that the at least one magnetic element 12 is arranged in the interior 23 of the float 11. In particular, the magnetic element 12 is configured as a ring element. The arrangement of more than two magnetic elements 12 in the interior 23 of the float 11 is not shown. The arrangement of the at least one magnetic element 12 or of the plurality of magnetic elements 12 in the interior 23 prevents otherwise possible corrosion of the at least one magnetic element 12 or of all magnetic elements 12 arranged in the interior 23.

The illustrated embodiments of the float 11 show a float 11 with a cylindrical design. In particular, it is configured as a hollow cylinder. A spherical, cubic or cuboid design or other geometric designs of float 11 is not shown.

As shown in FIGS. 5a to 5d, the float 11 is formed of at least two parts. The float 11 comprises a lid element 17 and a base element 18. The lid element 17 and the base element 18 are configured in particular such that they form the interior 23 when joined together. The lid element 17 and the base element 18 are adapted to fit together with a form-fitting, force-fitting and/or bonded connection. When joined together, the lid element 17 and the base element 18 enclose the possible interior 23. In some embodiments, the base element 18 and the lid element 17 can be fitted together. FIG. 5d shows an embodiment of the float 11 in which the float 11 is configured as a hollow body. The interior 23 is formed by a recess 26, which extends at least partially in the lid element 17 and/or in the base element 18. Only the variant in which the recess 26 extends at least partially only in the base element 18 is shown.

As shown in FIGS. 5a to 5d, the float 11 has an upper side O and an underside U. The upper side O is the side of the lid element 17 facing away from the base element 18 in the direction of the buoyancy force. The underside U is the side of the base element 18 facing away from the lid element 17 and opposite to the direction of the buoyancy force.

In the embodiment shown in FIGS. 5c and 5d, the lid element 17 has a fluid-draining surface topology on the upper side O, in particular on the side facing away from the base element 18 in the direction of the buoyancy force. Thus, for example, it can be seen that at least part of the upper side O of the lid element 17 is conical in shape. Further variants of the design of at least part of the upper side O of the lid element 17, which are, for example, pyramid-shaped, paraboloid, convex or hemispherical, are not shown. The aspect of such designs of the lid element 17 is that they achieve a better distribution of the collected leakage fluid LF in the collecting vessel 8, in particular a delay-free flow past the outer walls of the float 11. In particular, this leads to more reproducible detection of the filling time t_{S} and the filling cycle times t_{Z}.

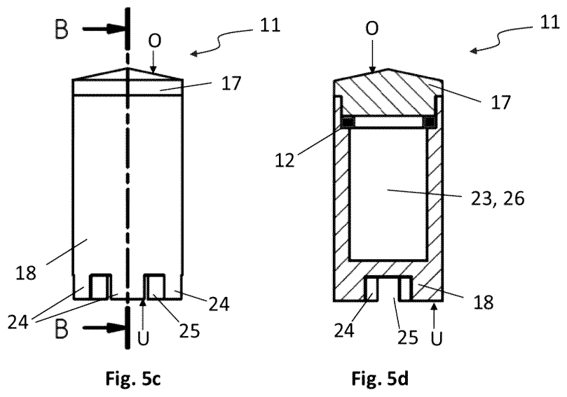

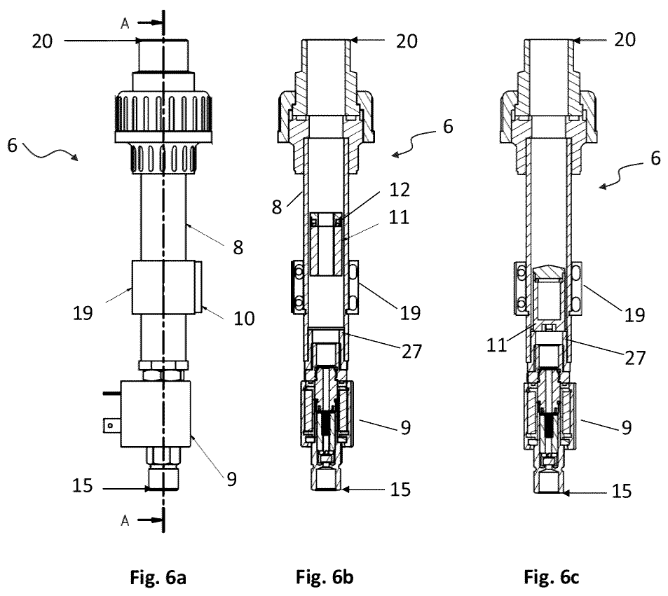

FIG. 6c shows a sectional view of an embodiment of the measuring unit 6 with the float 11 in the embodiment as shown in FIGS. 5c and 5d. The shown position of the float 11 in the collecting vessel 8 is the position after the leakage fluid LF is drained by opening the shut-off element 9. In this variant, the shut-off element 9 is designed as a solenoid valve. A support surface of the underside U—not shown in the drawing—or the underside U, on a lower outer side of the base element 18 of the float 11—not shown in the drawing—rests on a support element 27 after the leakage fluid LF has been drained.

In the embodiment of the float 11 shown in FIGS. 5c and 5d, the base element 18 has at least one spacer element 24 on the underside U, namely on the side facing away from the lid element 17, which is adapted to ensure the flow of leakage fluid LF between the support element 27 of the collecting vessel 8 and the base element 18, in particular in the region of the underside U. If the underside U of the float 11 were to rest with its whole surface on the support element 27, it would be more difficult to detach the float 11 from the support element 27, which would adversely affect the detection of the filling time t_{S} and the filling cycle times t_{Z}. The detection of the filling time t_{S} and the filling cycle times t_{Z} is thus reliably maintained and is therefore reproducible and highly accurate. In other words, the float 11 is arranged in such a way that it only rests on part of the surface.

As shown in FIGS. 5c and 5d, a plurality of spacer elements 24 form channels 25 open on one side, in some embodiments, extending over the entire cross-section of the base element 18 of the float 11. These channels 25, which are arranged on the underside U and are open on one side, allow the leakage fluid LF to flow between the support element 27 of the collecting vessel 8 and the underside U of the base element 18 when the collecting vessel 8 is being filled.

Furthermore, FIGS. 5a and 5b show the embodiment of the float 11 which has a through-recess 22 extending from the lid element 17 to the base element 18. This also serves to improve the distribution of the leakage fluid LF when the collecting vessel 8 is being filled, as it can flow not only between the outer wall of the float 11 and the inner wall or inner walls of the collecting vessel 8, but also in the through-recess 22.

As shown in FIG. 5b, the recess 26 is designed as a first groove-like recess in the lid element 17 which recess is configured as an open groove in the direction of the outer wall of the hollow cylindrical base element 18. In some embodiments, a second groove-like recess—not shown in the drawing—is provided in the base element 18, which is configured as an open groove in the direction of the through-recess 22. When the lid element 17 and base element 18 are joined together, the first groove-like recess and the second groove-like recess form the interior 23.

In some embodiments, the lid element 17 and the base element 18 are joined together with a form-fitting, force-fitting and/or materially bonded connection. For example, they are glued together in a form-fitting manner or configured with a sealing element, thus preventing the ingress of fluid, in particular leakage fluid LF, when the collecting vessel 8 is being filled. This prevents corrosion of the at least one magnetic element 12 or of all magnetic elements 12 arranged in the interior 23.

FIGS. 6a and 6b show an embodiment of the measuring unit 6 of the monitoring apparatus 1 according to the present disclosure. In some embodiments, the collecting vessel 8 is configured as a tube, made for example of transparent material, such as PVC.

In some embodiments, the tube has an inner diameter that is approximately two to four millimetres larger than the outer diameter of the float 11, which is configured as a hollow cylinder.

The float 11 is illustrated in the sectional drawing 6b, which shows a section through the axis A-A. The measuring unit 6 has the position determination device—not shown in the drawing—which is adapted to determine at least one position of the float 11. In some embodiments, the position determination device comprises the shown collecting vessel 8 with the reed contact 10 arranged thereon and a magnetic element 12 connected to the float 11.

In some embodiments, the measuring unit 6 further has a connection element 20 for attaching the measuring unit 6, for example to the bearing housing 3.2. This creates a fluid-conducting connection between the leakage fluid outlet opening 14 (see FIG. 4) and the collecting vessel 8 for collecting the leakage fluid LF. In some embodiments, the measuring unit 6 has a fastening element 19 for positioning the at least one reed contact 10. This is adapted to set the fill level or fill height, in particular the lowest fill level H_{R}, at which the reed contact 10 generates a switching signal.

This switching signal is used during initial filling to determine the initial filling time t_{S0} after the pump test run or pump run has started and also in the subsequent filling cycles to determine the filling cycle time t_{Z} from the time difference between two successive switching signals or filling switching signals.

In some embodiments, the shut-off element 9 is in the form of a solenoid valve, is arranged on the collecting vessel 8. The measuring unit 6 or the control unit 7 is configured to open the shut-off element 9 when the at least one fill level H_{R} is reached and after the switching signal has been generated by the reed contact 10, to drain the accumulated leakage fluid LF and then to close the shut-off element 9 again. In some embodiments, the leakage fluid LF is drained via the drain 15.

In the illustrated variant of the measuring unit 6 in FIGS. 6a and 6b, the reed contact 10 is arranged on the collecting vessel 8 in such a way that, when the measuring unit 6 is ready for operation and the collecting vessel 8 is empty, the reed contact 10 is closed and this switching state of the reed contact 10 is detected as the idle state signal. When the at least one fill level H_{R} is reached, the reed contact 10 is opened and the filling switching signal is generated. This position of the float 11 is schematically illustrated in FIG. 6b. For the sake of simplicity, the accumulated leakage fluid LF is not shown. This filling switching signal is used during initial filling to determine the initial filling time t_{S0} after the pump test run or pump run has started and also in the subsequent filling cycles to determine the filling cycle time t_{Z} from the time difference between two successive filling switching signals.

The embodiment of the monitoring apparatus 1 according to the present disclosure with the measuring unit 6, as shown in FIG. 6a and FIG. 6b, is configured so that the open reed contact 10 is detected by the control unit 7 or the measuring unit 6 as a filling switching signal and the filling cycle time t_{Z} is determined from the time difference between two successive filling switching signals. In some embodiments, the monitoring apparatus 1 is configured and adapted so that the closed reed contact 10 is detected as an idle state signal when the collecting vessel 8 is empty and a stop signal Sₛₜₒₚ is generated to switch off the sprinkler pump 2 or the pump 2 when a predefined warning time is exceeded, or no start signal is generated for the drive A of the sprinkler pump 2 or the pump 2.

In particular, the monitoring apparatus 1 is configured to open the shut-off element 9 for the drain time t_{A} before the initial filling of the collecting vessel 8 after the pump test run or pump run is started. This makes it possible to create defined starting conditions for detecting the leakage fluid LF passing into the dry chamber. For example, an absent idle state signal within the predefined warning time is detected if the shut-off element 9 or the reed contact 10 is defective or the float 11 has become jammed in the collecting vessel 8. This is a cost-effective way of monitoring the functionality of the monitoring apparatus 1, as no further resources are required in addition to those already available.

FIG. 6c shows a sectional view of an embodiment of the measuring unit 6 of the monitoring apparatus 1 according to the present disclosure, which is identical to the variant shown in FIG. 6b except for the float 11. In FIG. 6b, the float 11 is configured as described in FIGS. 5a and 5b, and in FIG. 6c as described in FIGS. 5c and 5d.

The previous remarks on the design of the apparatus according to the present disclosure also apply analogously to the details described below in connection with the method according to the present disclosure.

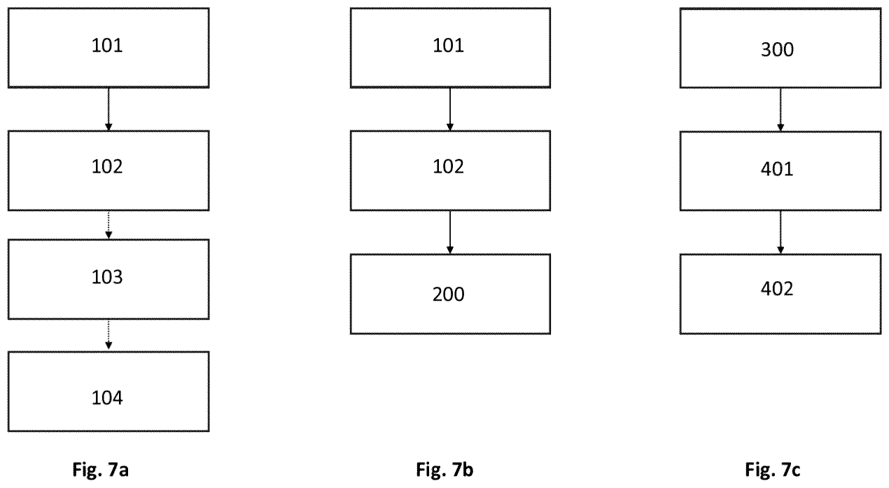

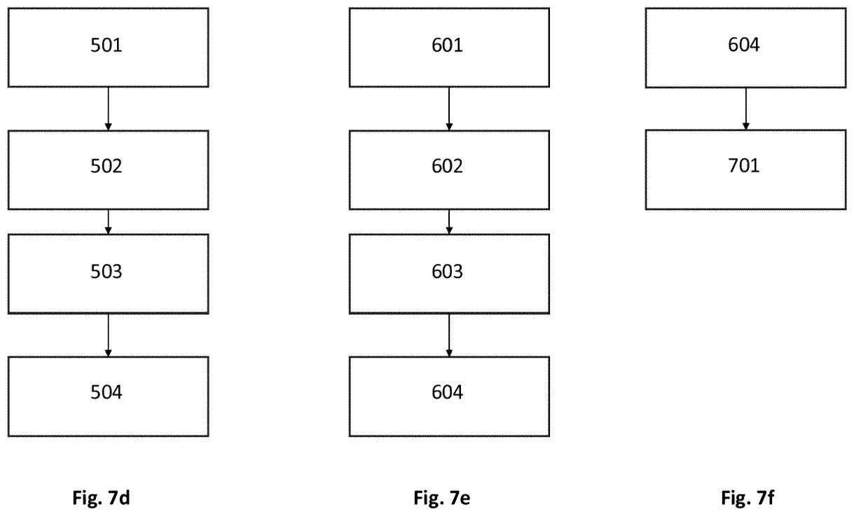

FIG. 7a shows a schematic flowchart of the method according to the present disclosure for monitoring a pump test run of a sprinkler pump 2 and the method according to the present disclosure for monitoring a pump 2. FIGS. 7b to 7e show different embodiments of the method. The sprinkler pump 2 or pump 2 comprises at least one pump housing 3.1 surrounding the wet chamber, the drive shaft 4 arranged sealed against the pump housing 3.1 by a gland packing 5, and a drive A mechanically coupled to the drive shaft 4. The gland packing 5 is configured and adapted for the passage of leakage fluid LF from the pump housing 3.1 into the dry chamber. The method comprises the following method steps during the pump test run or during the pump run:
Detection 101 of the leakage fluid LF passing from the pump housing 3.1 via the gland packing 5 into the dry chamber by a measuring unit 6 of a monitoring apparatus 1.
Generation 102 of the alarm signal and/or the stop signal Sₛₜₒₚ to switch off the sprinkler pump 2 or the pump 2 if the flow rate falls below the predefined minimum.

The method is further characterised in that the monitoring apparatus 1 has a control unit 7, the control unit 7 being connected to the measuring unit 6 and the drive A in a signal-conducting manner, the generation 102 of the alarm signal and/or the stop signal Sₛₜₒₚ to switch off the sprinkler pump 2 or the pump 2 taking place by the control unit 7 or the measuring unit 6.

In some embodiments of the method, the following method steps are optionally carried out after the pump test run or the pump run is started, and in some embodiments, before a regular, non-test run start of the drive A:
Checking 103 whether an idle state signal is present within a predefined warning time and
Generation 104 of a warning signal if the predefined warning time is exceeded without the idle state signal being detected, the idle state signal representing a state of operational readiness of the measuring unit 6.

FIG. 7b shows a further method step:
Detection 200 of the leakage fluid LF in a collecting vessel 8 based on at least one fill level H_{R} of the leakage fluid LF in the collecting vessel 8 by the measuring unit 6.

The steps of detection 101 and generation 102 shown in FIG. 7b correspond to those explained above.

In a further embodiment of the method, as shown in FIG. 7c, in the method step 300 the alarm signal and/or the stop signal Sₛₜₒₚ to switch off the sprinkler pump 2 or the pump 2 is generated by the control unit 7 or the measuring unit 6 if, during an initial filling of the collecting vessel 8, the at least one fill level H_{R} of the leakage fluid LF in the collecting vessel 8 is not reached within a predefined initial filling time t₀. Furthermore, FIG. 7c shows other optionally method steps for the initial filling of the collecting vessel 8:
Checking 401 by the measuring unit 6 or the control unit 7 whether an initial filling time t_{S0} until the at least one fill level H_{R} is reached satisfies a first inequality t_{S0}<t₀ and
Detection 402 of filling times t_{S} until the at least one fill level H_{R} is reached in further filling cycles when the first inequality is satisfied, by the measuring unit 6 or the control unit 7.

FIG. 7d shows further method steps that are carried out by the measuring unit 6 or the control unit 7:
Opening 501 of a shut-off element 9 arranged on the collecting vessel 8 in order to drain the accumulated leakage fluid LF when the at least one fill level H_{R} is reached.
Closing 502 of the shut-off element 9.
Detection 503 of a filling cycle time t_{Z} between two successive fillings of the collecting vessel 8 until the at least one fill level H_{R} is reached again.
Generation 504 of the alarm signal and/or the stop signal Sₛₜₒₚ to switch off the sprinkler pump 2 or the pump 2 when t_{Z} satisfies a second inequality t_{Z}>t₁ where t₁ is a predefined filling cycle time t₁.

In some embodiments, the filling cycle time t_{Z} satisfies the equation t_{Z}=t_{S}+t_{A}, where t_{A} is a predefined drain time between opening and closing the shut-off element 9 to drain the accumulated leakage fluid LF.

Further method steps are shown schematically in FIG. 7e:
Detection 601 of the leakage fluid LF with a float 11 movably arranged in the collecting vessel 8.
Detection 602 of the at least one fill level H_{R} based on the position of the float 11 by the measuring unit 6, and optionally.
Determination 603 of at least one position of the float 11 by the position determination device.

A further optional method step is also shown:
Detection 604 of the initial filling time t_{S0}, the filling time t_{S} or the filling cycle time t_{Z} by the position determination device.

FIG. 7f shows a further optional method step which comprises the detection 701 of the initial filling time t_{S0} and the filling cycle time t_{Z} when a switching state of the at least one reed contact 10 changes, the position determination device being formed by the at least one reed contact 10 arranged on the collecting vessel 8 and at least one magnetic element 12 connected to the float 11, or by the at least one reed contact 10 arranged on the collecting vessel 8, and a float 11 made of a magnetic material.

1. A monitoring apparatus for a pump test run of a sprinkler pump, the sprinkler pump comprises:
at least one pump housing surrounding a wet chamber,
a drive shaft arranged sealed against the pump housing by a gland packing, and
a drive mechanically coupled to the drive shaft, the gland packing being configured for the passage of leakage fluid from the pump housing into a dry chamber,
the monitoring apparatus comprises a measuring unit adapted to detect the leakage fluid passing through the gland packing from the pump housing into the dry chamber during the pump test run, and the measuring unit is configured to generate a stop signal to switch off the sprinkler pump and/or an alarm signal when the flow rate falls below a predefined minimum.

2. The monitoring apparatus according to claim 1, wherein the monitoring apparatus also has a control unit, the control unit being connected to the measuring unit and the drive in a signal-conducting manner, the control unit or the measuring unit being configured to generate the alarm signal and/or the stop signal to switch off the sprinkler pump.

3. The monitoring apparatus according to claim 2, wherein the measuring unit comprises a collecting vessel configured to detect the leakage fluid and the measuring unit is configured to detect the leakage fluid in the collecting vessel based on at least one fill level.

4. The monitoring apparatus according to claim 3, wherein the measuring unit or the control unit is adapted to generate the alarm signal and/or the stop signal to switch off the sprinkler pump when, during an initial filling of the collecting vessel, the at least one fill level of the leakage fluid in the collecting vessel is not reached within a predefined initial filling time t₀.

5. The monitoring apparatus according to claim 4, wherein the measuring unit or the control unit is configured to check whether, during the initial filling of the collecting vessel, an initial filling time t_{S0} until the at least one fill level is reached satisfies a first inequality t_{S0}<t₀ and is also configured to detect, when the first inequality is satisfied, filling times t_{S} until the at least one fill level is reached in further filling cycles.

6. The monitoring apparatus according to claim 5, wherein a shut-off element is arranged on the collecting vessel, and the measuring unit or the control unit is configured to open the shut-off element to drain the accumulate leakage fluid and then to close the shut-off element when the at least one fill level is reached, and configured to detect a filling cycle time t_{Z} between two successive fillings of the collecting vessel until the at least one fill level is reached again, and to generate the alarm signal and/or the stop signal to switch off the sprinkler pump when t_{Z} satisfies a second inequality t_{Z}>t₁ where t₁ is a predefined filling cycle time t₁.

7. The monitoring apparatus according to claim 6, wherein the filling cycle time t_{Z} satisfies the equation t_{Z}=t_{S}+t_{A}, where t_{A} is a predefined drain time between opening and closing the shut-off element to drain the accumulated leakage fluid.

8. The monitoring apparatus according to claim 7, wherein a float configured to detect the leakage fluid is movably arranged in the collecting vessel and the measuring unit is configured to detect the at least one fill level based on the position of the float.

9. The monitoring apparatus according to claim 8, wherein the measuring unit comprises a position determination device configured to determine at least one position of the float.

10. The monitoring apparatus according to claim 9, wherein the position determination device comprises at least one reed contact arranged on the collecting vessel and at least one magnetic element connected to the float or the float formed from a magnetic material.

11. The monitoring apparatus according to claim 10, wherein the control unit is connected to the at least one reed contact in a signal-conducting manner, and the measuring unit or the control unit is also configured to detect the initial filling time t_{S0} and the filling cycle times t_{Z} when the switching state of the at least one reed contact is changed by the magnetic element of the float or by the float made of the magnetic material, when the at least one fill level is reached.

12. The monitoring apparatus according to claim 10, wherein the float is configured with an interior enclosed on all sides, in which the at least one magnetic element is arranged.

13. The monitoring apparatus according to claim 12, wherein the float is solid or hollow and has a cylindrical, spherical, cube or cuboid shape.

14. The monitoring apparatus according to claim 12, wherein the float is formed of at least two parts and comprises a lid element and a base element, the lid element and the base element being configured in such a way that they form the interior when joined together.

15. The monitoring apparatus according to claim 14, wherein the interior is formed by a recess which extends at least partially in the lid element and/or in the base element.

16. The monitoring apparatus according to claim 15, wherein the lid element has a fluid-draining surface topology on the side facing away from the base element.

17. The monitoring apparatus according to claim 14, wherein the base element has at least one spacer element on a side facing away from the lid element, which ensures the flow of the leakage fluid between a support element of the collecting vessel and the base element.

18. The monitoring apparatus according to claim 14, wherein the float has a through-recess which extends from the lid element to the base element.

19. The monitoring apparatus according to claim 8, wherein a cross-sectional geometry of the collecting vessel is at least substantially similar to a cross-sectional geometry of outer walls of the float, so that the outer walls of the float are spaced on all sides from inner walls of the collecting vessel, while maintaining a minimum distance from one another.

20. A method for monitoring a pump test run of a sprinkler pump, the sprinkler pump comprises:
at least one pump housing surrounding a wet chamber,
a drive shaft arranged sealed against the pump housing by a gland packing, and
a drive mechanically coupled to the drive shaft, the gland packing being configured for the passage of leakage fluid from the pump housing into a dry chamber,
the method comprising the steps of:
detecting the leakage fluid passing from the pump housing via the gland packing into the dry chamber during the pump test run by a measuring unit of a monitoring apparatus; and
generating an alarm signal and/or a stop signal to switch off the sprinkler pump when the flow rate falls below a predefined minimum.

21. The method according to claim 20, wherein the monitoring apparatus includes a control unit being connected to the measuring unit and the drive in a signal-conducting manner, and
wherein the generation of the alarm signal and/or the stop signal to switch off the sprinkler pump taking place by the control unit or the measuring unit.

22. The method according to claim 21 further comprising:
detecting the leakage fluid in a collecting vessel based on at least one fill level of the leakage fluid in the collecting vessel by the measuring unit.

23. The method according to claim 22 further comprising:
generating the alarm signal and/or the stop signal to switch off the sprinkler pump by the control unit or the measuring unit when, during an initial filling of the collecting vessel, the at least one fill level of the leakage fluid in the collecting vessel is not reached within a predefined initial filling time t₀.

24. The method according to claim 23, wherein during the initial filling of the collecting vessel the method further comprises:
checking by the measuring unit or the control unit whether an initial filling time t_{S0} until the at least one fill level is reached satisfies a first inequality t_{S0}<t₀; and
detecting filling times t_{S} until the at least one fill level is reached in further filling cycles when the first inequality is satisfied, by the measuring unit or the control unit.

25. The method according to any of claim 24 further comprising:
opening, by the measuring unit or the control unit, a shut-off element arranged on the collecting vessel in order to drain the accumulated leakage fluid when the at least one fill level is reached;
closing, by the measuring unit or the control unit, the shut-off element;
detecting, by the measuring unit or the control unit, a filling cycle time t_{Z} between two successive fillings of the collecting vessel until the at least one fill level is reached again; and
generating, by the measuring unit or the control unit, the alarm signal and/or the stop signal to switch off the sprinkler pump when t_{Z} satisfies a second inequality t_{Z}>t₁ where t₁ is a predefined filling cycle time t₁.

26. The method according to claim 25, wherein the filling cycle time t_{Z} satisfies the equation t_{Z}=t_{S}+t_{A}, where t_{A} is a predefined drain time between opening and closing the shut-off element to drain the accumulated leakage fluid.

27. The method according to claim 26 further:
detecting the leakage fluid with a float movably arranged in the collecting vessel;
detecting the at least one fill level based on the position of the float by the measuring unit; and
determining at least one position of the float by a position determination device.

28. The method according to claim 27 further comprising:
detection of the initial filling time t_{S0} and the filling cycle time t_{Z} when a switching state of at least one reed contact changes, the position determination device being formed by the at least one reed contact arranged on the collecting vessel and at least one magnetic element connected to the float, or by the at least one reed contact arranged on the collecting vessel, and the float made of a magnetic material.

29. Water extinguishing system with the monitoring apparatus according to claim 1.
